(19) United States
(12) Patent Application Publication
(10) Pub. No.: US 2006/0015578 A1
(43) Pub. Date: Jan. 19, 2006

(54) Retrieving dated content from a website

(75) Inventors: Dwip N. Banerjee, Austin, TX (US); Lilian Sylvia Fernandes, Austin, TX (US); Vinit Jain, Austin, TX (US); Vasu Vallabhaneni, Austin, TX (US)

Correspondence Address: INTERNATIONAL CORP (BLF), c/o BIGGERS & OHANIAN, LLP, P.O. BOX 1469, AUSTIN, TX, 78767-1469, US

(73) Assignee: INTERNATIONAL BUSINESS MACHINES CORPORATION, ARMONK, NY (US)

(21) Appl. No.: 10/889,785

(22) Filed: Jul. 13, 2004

(51) Int. Cl. G06F 15/16

(52) U.S. Cl. 709/219; 709/203

(57) ABSTRACT

Retrieving dated content from a website including receiving a URL for dated content with a date field; inserting the current date in the date field; and retrieving the dated content with the URL bearing the current date in its date field. In some embodiments, date field bears an encoded date and inserting the current date in the date field includes replacing the encoded date with the current date. Typical embodiments also include bookmarking the URL, including replacing an encoded date in the date field with a date tag. Some embodiments include prompting the user for a date format. In many embodiments, the date tag includes a default date format. Some embodiments include configuring the browser with a default date format.

### BACKGROUND OF THE INVENTION

1. Field of the Invention

The field of the invention is data processing, or, more specifically, methods, systems, and products for retrieving dated content from a website.

2. Description of Related Art

Websites often have links to web pages which change daily such as web pages that list sports scores, web pages that include movie reviews, web pages that include a recipe of the day, web pages that include a daily newspaper columns by a journalist an so on. Often such web pages are identified by URLs having a date value in the URL itself, such as, for example, this URL:
http://foodtv.com/receipe06122004.html
   that includes a date value for Jun. 12, 2004. Users often visit these web pages daily. To access the daily version of the web page, users must normally go to a main page of the main website and click on the link for the day. Such users cannot effectively bookmark the URL for the daily changing web content if the URL is itself date specific. That is, the next day the URL will not point to the daily page for that day, but will still point instead to the daily page for yesterday. Since the link itself changes everyday, a user cannot bookmark the URL and later retrieve dated content for the current day.

### SUMMARY OF THE INVENTION

Methods, systems, and computer program products are disclosed for retrieving dated content from a website that include receiving a URL for dated content with a date field; inserting the current date in the date field; and retrieving the dated content with the URL bearing the current date in its date field. In some embodiments, date field bears an encoded date and inserting the current date in the date field includes replacing the encoded date with the current date.

Typical embodiments also include bookmarking the URL, including replacing an encoded date in the date field with a date tag. Some embodiments include prompting the user for a date format. In many embodiments, the date tag includes a default date format. Some embodiments include configuring the browser with a default date format. In many embodiments, inserting the current date in the date field includes replacing the date tag with the current date. In many embodiments, receiving a URL for dated content with a date field includes providing the date field in the form of a date tag, where inserting the current date in the date field includes replacing the date tag with the current date. Many embodiments include bookmarking the URL, including a date field.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 depicts an exemplary data processing system capable of retrieving dated content from a website according to embodiments of the present invention.

FIG. 2 sets forth a block diagram of automated computing machinery comprising a computer useful in retrieving dated content from a website according to embodiments of the present invention.

FIG. 3 sets forth a flow chart illustrating an exemplary method for retrieving dated content from a website.

FIG. 4 sets forth a flow chart illustrating an exemplary method for bookmarking a URL for dated content.

FIG. 5 depicts a graphical user interface of an exemplary browser in accordance with the present invention.

### DETAILED DESCRIPTION OF EXEMPLARY EMBODIMENTS

### Introduction

The present invention is described to a large extent in this specification in terms of methods for retrieving dated content from a website. Persons skilled in the art, however, will recognize that any computer system that includes suitable programming means for operating in accordance with the disclosed methods also falls well within the scope of the present invention. Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit.

The invention also may be embodied in a computer program product, such as a diskette or other recording medium, for use with any suitable data processing system. Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### Retrieving Dated Content from a Website

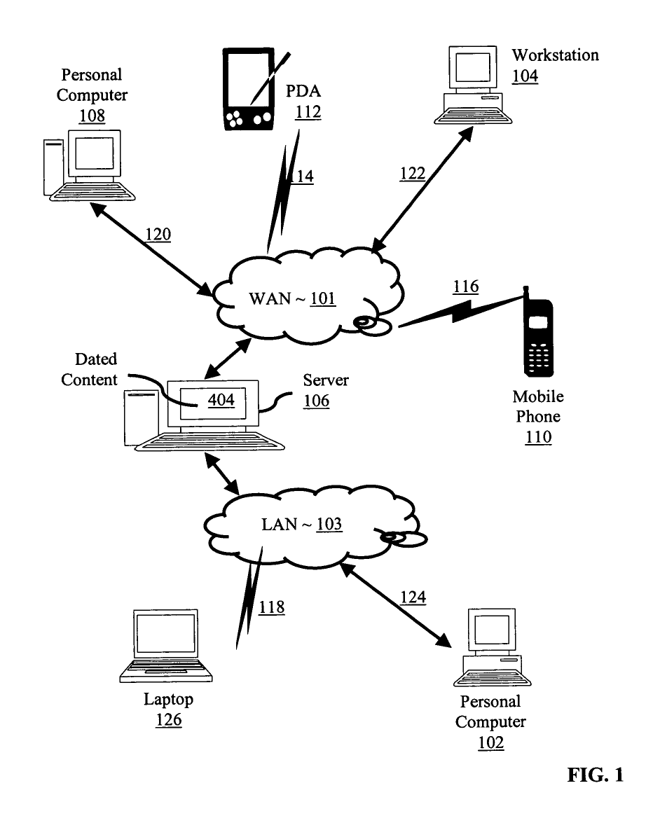

Exemplary methods, systems, and products for retrieving dated content from a website are now explained with reference to the accompanying drawings, beginning with FIG. 1. FIG. 1 depicts an exemplary data processing system capable of retrieving dated content from a website according to embodiments of the present invention. The system of FIG. 1 operates generally by receiving a URL for dated content with a date field; inserting the current date in the date field; and retrieving the dated content with the URL bearing the current date in its date field. In this specification “dated content” means any resource identified by a URL bearing a date field. Dated content often includes web pages, dynamically generated web content, and other resources that contain current information such as news, daily sports scores, daily recipes and so on as will occur to those of skill in the art. Dynamically generated web content includes the output of CGI (‘Common Gateway Interface’) scripts, Java™ servlets, and other server-side functionality for dynamic generation of web content as will occur to those of skill in the art.

The system of FIG. 1 includes a number of computers connected for data communications in networks. Each of the computers of the system of FIG. 1 may have installed upon it a data communications client, such as, for example, a browser, modified in accordance with the present invention. A ‘browser,’ as the term is used in this specification, generally means a web browser, a software application for locating, requesting, retrieving, and displaying computer resources in the form of static or dynamic web pages or server-side scripting output. Browsers typically comprise both a markup language interpreter, web page display routines, and an HTTP communications client. Typical browsers today can display text, graphics, audio and video. Browsers are operative in any computer capable of data communications including web-enabled devices, wireless web-enabled devices, microcomputers, PDAs, laptops, and so on. Browsers in wireless web-enabled devices often are downsized browsers called “microbrowsers.” Browsers typically support not only HTML (the ‘HyperText Markup Language’), but other markup languages as well, including for example, XML (the ‘eXtensible Markup Language’), and, in the case of wireless web-enabled devices, WML (the ‘Wireless Markup Language’) and HDML (the ‘Handheld Device Markup Language’).

The data processing system of FIG. 1 includes wide area network (“WAN”) (101) and local area network (“LAN”) (103). The network connection aspect of the architecture of FIG. 1 is only for explanation, not for limitation. In fact, systems for retrieving dated content from a website according to embodiments of the present invention may be connected as LANs, WANs, intranets, internets, the Internet, webs, the World Wide Web itself, or other connections as will occur to those of skill in the art. Such networks are media that may be used to provide data communications connections between various devices and computers connected together within an overall data processing system.

In the example of FIG. 1, server (106) implements a gateway, router, or bridge between LAN (103) and WAN (101). “Server” in this specification refers to a computer or device comprising automated computing machinery on a network that manages network resources. A “web server” in particular is a server that communicates with browsers by means of HTTP in order to manage and make available to networked computers markup language documents and digital objects. In the example of FIG. 1, the server (106) makes available a dated content (404). Dated content (404) may be any computer resource identified by and made available through the use of a URL (“Uniform Resource Locator”) bearing a date field. The dated content may be any resource as will occur to those of skill in the art. In fact, the ‘R’ in ‘URL’ stands for ‘resource.’ Network communications protocols generally, for example, HTTP, TCP/IP, and so on, transmit resources, not just files. The most common kind of resource is a file, but resources include dynamically-generated query results as well, such as the output of CGI (‘Common Gateway Interface’) scripts, Java servlets, dynamic server pages, documents available in several languages, and so on. In effect, a resource is somewhat similar to a file, but more general in nature. Resources implemented as files include static web pages, graphic image files, video clip files, audio clip files, and so on. As a practical matter, most resources are currently either files or server-side script output. Server side script output includes output from CGI programs, Java servlets, Active Server Pages, Java Server Pages, and so on.

Server (106) may be any computer capable of accepting a request for dated content and responding by providing the dated content to the requester. One example of such a server is an HTTP (‘HyperText Transport Protocol’) server or ‘web server.’ In the example of FIG. 1, several exemplary devices capable of supporting a data communications application modified according to the present invention to retrieve dated content including a PDA (112), a computer workstation (104), a mobile phone (110), and personal computer (108) are connected to WAN (101). Network-enabled mobile phone (110) connects to WAN (101) through wireless link (116), and PDA (112) connects to network (101) through wireless link (114). In the example of FIG. 1, personal computer (108) connects through wireline connection (120) to WAN (101), and computer workstation (104) connects through wireline connection (122) to WAN (101). Laptop (126) connects through wireless link (118) to LAN (103), and personal computer (102) connects through wireline connection (124) to LAN (103).

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP/IP, HTTP, WAP, HDTP, and others as will occur to those of skill in the art. Various embodiments of the present invention may be implemented on a variety of hardware platforms in addition to those illustrated in FIG. 1.

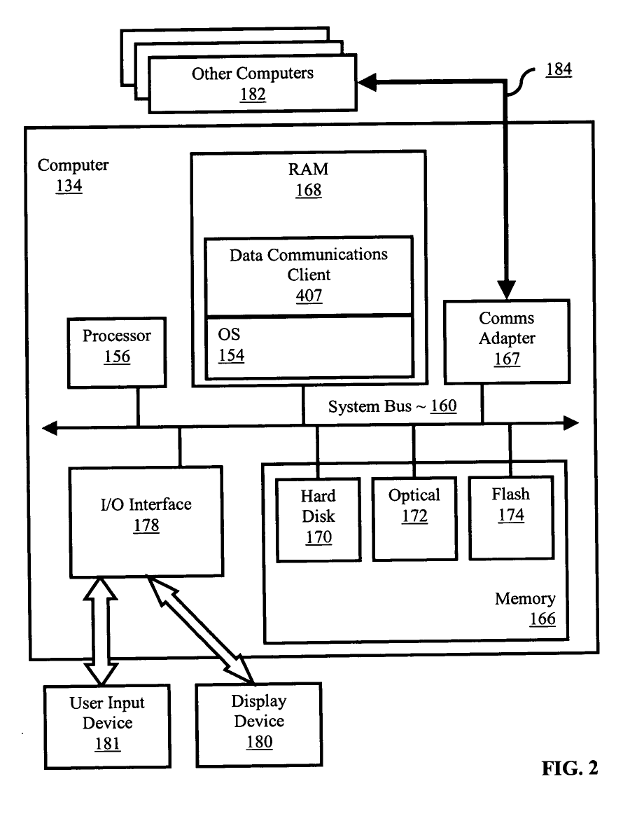

As mentioned above, retrieving dated content from a website in accordance with the present invention is generally implemented with computers, that is, with automated computing machinery. For further explanation, FIG. 2 sets forth a block diagram of automated computing machinery comprising a computer (134) useful in retrieving dated content from a website according to embodiments of the present invention. The computer (134) of FIG. 2 includes at least one computer processor (156) or ‘CPU’ as well as random access memory (168) (“RAM”). Stored in RAM (168) is a data communications client (407) such as a browser. Also stored in RAM (168) is an operating system (154). Operating systems useful in computers according to embodiments of the present invention include Unix, Linux, Microsoft NT™, and many others as will occur to those of skill in the art. Operating system (154) in the example of FIG. 2 is shown in RAM (154), but many components of an operating system typically are stored in non-volatile memory (166) also.

The computer (134) of FIG. 2 includes non-volatile computer memory (166) coupled through a system bus (160) to processor (156) and to other components of the computer. Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The exemplary computer (134) of FIG. 2 includes a communications adapter (167) for implementing connections for data communications (184), including connections through networks, to other computers (182), including servers, clients, and others as will occur to those of skill in the art. Communications adapters implement the hardware level of connections for data communications through which local devices and remote devices or servers send data communications directly to one another and through networks. Examples of communications adapters useful for retrieving dated content from a website according to embodiments of the present invention include modems for wired dial-up connections, Ethernet (IEEE 802.3) adapters for wired LAN connections, and 802.11b adapters for wireless LAN connections.

The example computer of FIG. 2 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

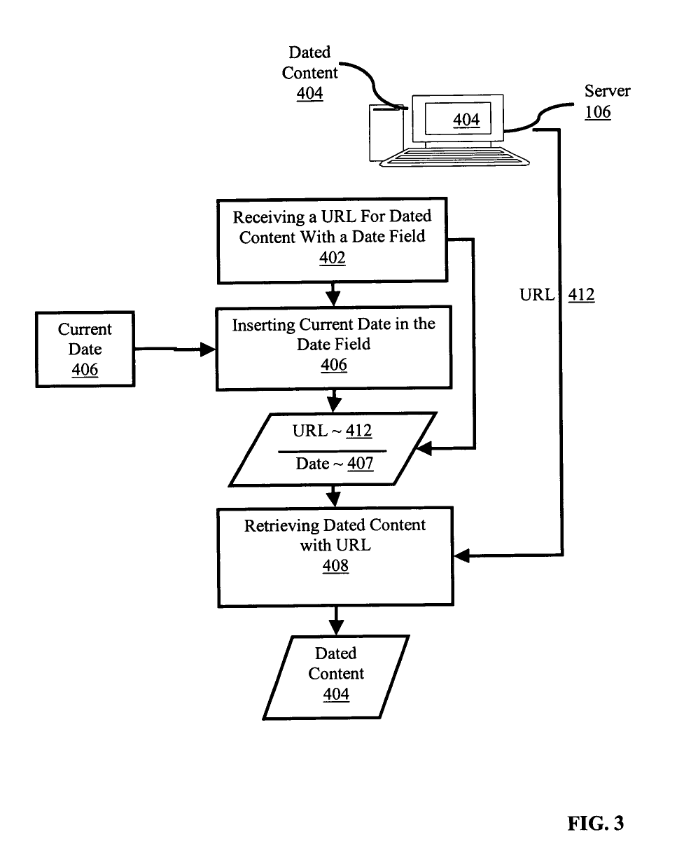

For further explanation, FIG. 3 sets forth a flow chart illustrating an exemplary method for retrieving dated content (404) from a website. The method of FIG. 3 includes receiving (402) a URL (412) for dated content (404) with a date field (407). The date field (407) of FIG. 3 may be implemented as an encoded date value within a URL such as for example the encoded date 06162004 representing the date Jun. 16, 2004 in the URL:
www.somesportspage.com/soccer/scores06162004

The date field (407) of FIG. 3 may also be implemented as a date tag such as <date=mmddyyy> identifying a date format in the URL:
www.somesportspage.com/soccer/scores<date=mmddyyy>

The date field (407) of FIG. 3 may also be implemented as an encoded date value in a data encoded URL. “URL encoded data” is data packaged in a URL for data communications. URL encoded data typically is encoded in name-values pairs as described in more detail below. In the case of HTTP communications, the HTTP GET and POST functions are often used to transmit URL encoded data. In this context, it is useful to remember that URLs do more than merely request file transfers. URLs identify resource on servers. Such resource may be files having filenames, but the resources identified by URIs also include, for example, queries to databases. Results of such queries do not necessarily reside in files, but they are nevertheless data resources identified by URLs identifying dated content and identified by a search engine and query data that produce such resources. An example of a date field in URL encoded data is:
http:\\www.somesportspage.com/cgi-bin/MyScript.cgi?sport=soccer&event=scores&date=06162004

This is an example of URI encoded data, which is how HTML forms typically are submitted over the web using HTTP GET request messages. This method using the GET message is useful when the amount of data to be encoded is fairly small. For larger amounts of data, it is more common to use HTTP POST messages for form submissions.

More specifically, the entire example above is a URI bearing encoded data, and the encoded data is the string “sport=soccer&event=scores&date=06162004” The encoding method is to string field names and field values separated by ‘&’ and “=” with spaces represented by ‘+.’ The data encoded URI identifies the date field with the name-value pair “date=06162004.” In this example the encoded date value in the date filed is ‘06162004’ representing the date Jun. 16, 2004. The examples in this specification of date fields (407) in URLs for dated content are illustrative and are not exhaustive of the many ways in which a date field may be implemented in a URL. In fact, there are many ways of implementing a date filed in a URL and all such ways of implementing a date field in a URL as will occur to those of skill in the art are within the scope of the present invention.

In the method of FIG. 3, receiving (402) a URL for dated content with a date field may be carried out by receiving in a browser, for example, the URL having a date field in a link in a web page. For example a web page, an HTML document, an XHL document, or the like, may include a plurality of hyperlinks to dated content each having within them a URL having a date tag. One example of a hyperlink having a URL with a date tag encoded date is:
<a href=“http:\\www.somesportspage.com/soccer/scores<date=mmddyyy>”>Today's Soccer Scores</a>

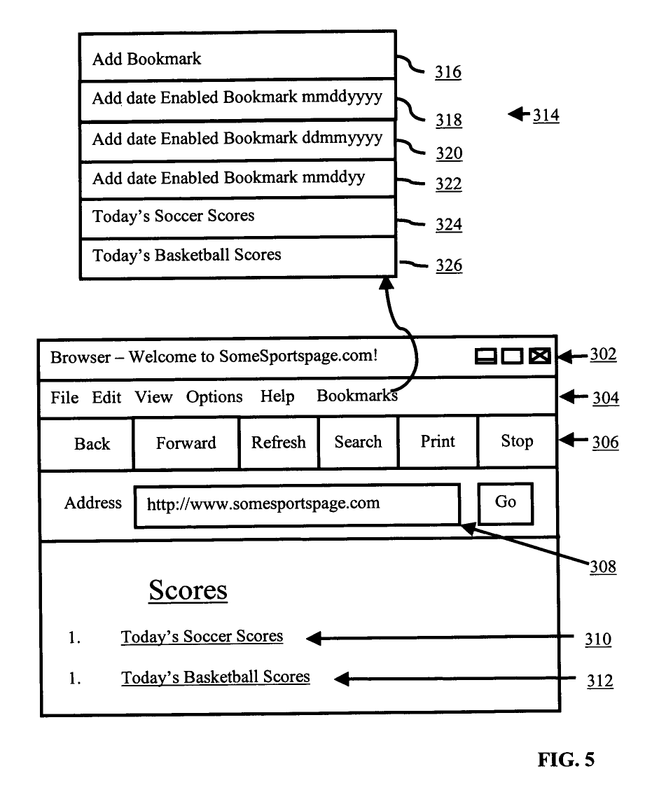

Providing hyperlinks to dated content through URLs with date tags advantageously allows system administrators supporting web pages with dated content to update only the dated content without having to change the links to the dated content. When a web page with links to the dated content is received and parsed in a browser, a browser modified in accordance with the present invention, parses each URL having a date tag and replaces the date tag with the current date. Receiving (402) a URL for dated content with a date field also may be carried out by a user's data entry in a browser address field (reference 308 on FIG. 5) and by a user's selection of an entry from a bookmark list (314 on FIG. 5),

The method of FIG. 3 includes inserting (406) the current date (406) in the date field (407) and retrieving (408) the dated content (404) with the URL (412) bearing the current date in its date field. In one example of the method of FIG. 3, inserting (406) the current date (406) in the date field (407) includes parsing the URL to identify an encoded date and replacing the encoded date with the current date. Consider the following example. A user invokes on Sep. 20, 2004 the following URL http:\\www.somesportspage.com/soccer/scores06162004 having a date field that includes an encoded date value 01162004 identifying dated content of Jun. 16, 2004. A browser modified in accordance with the present invention parses the URL, identifies the encoded date value, and replaces the encoded date with the current date. The browser may be modified to prompt a user for instructions to replace the encoded date value with the current date or ask a user to identify a particular date format. In this example, the resultant URL bearing the current date in the date field is http:\\www.somesportspage.com/soccer/scores09202004.

As discussed above, the date field (407) of the URL (412) of FIG. 3 may alternatively include a date tag instead of an encoded date. An example of a URL having a date tag instead of an encoded date value is:
http:\\www.somesportspage.com/soccer/scores<date=mmddyyy>

In this example the date tag <date=mmddyyy> includes a date format identifying the date format as two digits for month followed by two digits for day followed by four digits for year. In the method of FIG. 3 therefore inserting (406) the current date (406) in the date field (407) can also be carried out by replacing the date tag with the current date (406). Continuing with the example above, invoking the URL http:\\www.somesportspage.com/soccer/scores<date=mmddyyy> on Sep. 20, 2004 instructs a browser modified in accordance with the present invention to replace the date tag <date=mmddyyy> with the current date and request dated content through the user the URL:
http:\\www.somesportspage.com/soccer/scores09202004.

A browser modified to retrieve dated content from a website in accordance with the present invention may be modified to prompt a user for a date format prior to inserting the current date in the date field. Alternatively, a browser modified to retrieve dated content from a website in accordance with the present invention may be configured with a default date format. In such examples replacing an encoded date in the URL with the current date includes replacing the encoded date values with the current date in dependence upon the default date format. Similarly, in such examples, replacing a date tag in the URL with the current date is carried out by replacing the date tag with the current date in dependence upon the date format. Configuring a browser with a default date format advantageously provides a mechanism for replacing encoded dates and date tags without prompting the user for a date format or requiring a system administrator to identify the date format in a tag in a URL for the dated content. Browser configurations may vary from county to country in accordance with convention used in that county. For example, a browser in America may be configured with a date format of ‘mmddyyyy’ (two digits for month followed by two digits for day followed by for digits for year) while browser in Europe may be configured with a date format of ‘ddmmyyyy’ (two digits for day followed by two digits for month followed by for digits for year).

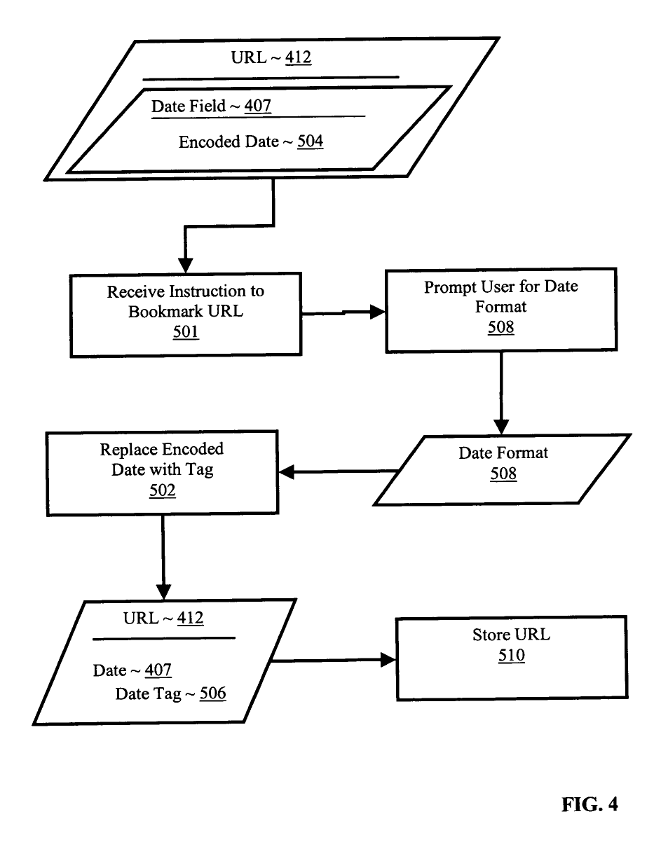

For further explanation, FIG. 4 sets forth a flow chart illustrating an exemplary method for bookmarking a URL for dated content. The term “bookmark” is used broadly to mean saving a URL for dated content. Many web browsers support bookmarking allowing a user to save the address (URL) of a Web page so that the user can easily revisit the page at a later time. In some browser applications such as for example Microsoft Outlook™ a bookmarking function is implemented through a “favorites list,” and the term ‘Favorites’ rather than the term ‘bookmark’ is used to identify the function. In this specification, the term ‘bookmark’ and ‘bookmarking’ are used broadly and may be implemented through the use of bookmarking features that are explicitly designated using the phrase ‘bookmark’ as well as bookmarking features called other names as will occur to those of skill in the art.

In the example of FIG. 4, a URL (412) includes a date field bearing an encoded date value (407) in a date field (407). The following is an example expressed in URL space of a URL that includes a date field bearing an encoded data value:
www.somesportspage.com/soccer/scores09202004

In this example, the subdirectory name ‘scores09202004’ includes a date field as its seventh through fourteenth characters, and the date field is encoded with a date in that its contents ‘09202004’ represent the date Sep. 20, 2004.

The method of FIG. 4 includes receiving (501) an instruction to bookmark a URL. Receiving (501) an instruction to bookmark a URL can be implemented, for example, through a software function made available through a GUI pull down menu in a browser such as that shown for example at references (316) on FIG. 5. A browser displaying the web page identified by the URL set forth just above, for example, when its ‘Add Bookmark’ function is invoked, thereby receives an instruction to bookmark that URL and does so by storing the URL in a bookmark or favorites list accessible to users through menu such as the one shown at reference (314) on FIG. 5.

The method of FIG. 4 also includes prompting (508) a user for a date format for the URL. A date format identifies the format in which the date value is encoded in the URL. For example, a date format of mmddyyyy identifies a date format of two digits for month followed by two digits for day followed by four digits for year. Similarly, mmddyyyy identifies a date format of two digits for month followed by two digits for day followed by two digits for year. The two examples of date formats are provided for clarity of explanation, not for limitation. In fact many date formats exist, and any date format that will occur to those of skill in the art is within the scope of the present invention. A user may be prompted for a date format with a GUI text box facilitating a user's entering a date format, with a menu of date formats from which the user may choose the date format, or by any other method of prompting a user for a date format as will occur to those of skill in the art.

In response to a user's selection of a date format, the method of FIG. 4 includes replacing (502) the encoded date (504) in the date field (407) with a date tag (506) storing (510) the URL (412) having the date tag (506) in the date field. Storing (510) the URL (412) having the date tag (506) in the date field is typically carried out by storing the URL in association with a descriptive identifier for the dated content thereby facilitating the user's invoking the bookmarked URL.

For further explanation, consider the following use case of a user bookmarking a URL bearing an encoded date value (407) in the date field:
http:\\www.somesportspage.com/soccer/scores06162004
   identifying soccer scores for Jun. 16, 2004. The exemplary URL bears an encoded date value of ‘06162004’ in its date field. A user instructs the browser to bookmark the exemplary URL with a GUI pull-down menu and a browser modified in accordance with the present invention prompts the user for a date format. The user enters in a GUI text box, selects from a pull-down menu, otherwise selects the date format mmddyyyy identifying a date format of two digits for month followed by two digits for day followed by two digits for year. In response to the users entry of a date format, the browser modified in accordance with the present invention replaces the encoded date value ‘06162004’ with a date tag <date-mmddyyy> and stores the following URL:
http:\\www.somesportspage.com/soccer/scores<date=mmddyyy>
   in association with a descriptive phrase identifying the dated content accessible through the URL.

As mentioned above, retrieving dated content from a website in accordance with the present invention is generally implemented through the use of data communications clients such as, for example, browsers. FIG. 5 depicts a graphical user interface (‘GUI’) of an exemplary software application program, more particularly, in the example of FIG. 5, a browser. The browser of FIG. 5 is an example of a software product improved according to embodiments of the present invention, that is, programmed at the source code level or modified with a plug-in to retrieve dated content from a website by inserting the current date in the date field of a URL for dated content and retrieving the dated content with the URL bearing the current date in its date field. The browser of FIG. 5 has also been modified to bookmark URLs for dated content in accordance with embodiments of the present invention. The example of FIG. 5 is taken as a browser for convenience of explanation, not for limitation. In fact, any software program may be improved according to embodiments of the present invention to retrieving dated content from a website, including, for example, word processor programs, spreadsheet programs, database management tools, and, of course, browsers.

The browser of FIG. 5, as depicted, has been operated to point to a web site named “SomeSportsPage.com,” as shown in the title bar of the browser display (302). The browser of FIG. 5 includes a GUI toolbar (306) with a Back button, a Forward button, and buttons for refreshing the display, searching, printing, and stopping web page retrievals. The browser of FIG. 5 also includes a horizontal menu (304) containing the menu items File, Edit, View, Options, and Bookmark (called ‘Favorites’ on some browsers). The exemplary browser of FIG. 5 includes an address bar (308), and invoking a URL for dated content may be carried out by entering the URL in a browser's address bar (308) and invoking the GUI Go button in the address bar with a mouseclick or carriage return. A URL so invoked is received as a URL for dated content with a date field in a data communications module of a browser according to embodiments of the present invention, parsed to discover its date field, after which the current date is inserted in the date field, and dated content identified by the URL so modified is retrieved by the browser from a web server.

Invoking a URL for dated content may also be carried out by invoking a hyperlink such as the exemplary hyperlinks (310 and 312) to dated content. A ‘hyperlink’ is a reference to a URL which when invoked requests access to a resource identified by the URL. The term ‘hyperlink’ in this specification includes links to URLs effected through anchor elements, as well as ‘Back’ and ‘Forward’ buttons on a toolbar in a GUI of a software application program. An anchor element is a markup language element that identifies and implements a hyperlink. An exemplary form of an anchor element implementing the exemplary hyperlink (310) of FIG. 5, here expressed in HTML, is:
<a href=“http:\\www.somesportspage.com/soccer/scores06162004”>Today's Soccer Scores</a>

This example anchor element includes a start tag <a>, and end tag </a>, an href attribute that identifies the target of the link as dated content located at http:\\www.somesportspage.com/soccer/scores06162004, and an anchor. In this example, the target of the link is a URL for dated content having an encoded dated value within the URL. The “anchor” is the display text that is set forth between the start tag and the end tag. That is, in this example, the anchor is the text “Today's Soccer Scores.” In typical usage, the anchor is displayed in highlighting, underscored, inverse, specially colored, or some other fashion setting it apart from other screen text and identifying it as an available hyperlink. In addition, the screen display area of the anchor is sensitized to user interface operations such as GUI pointer operations such as mouseclicks. In typical operation, a user points to the anchor with a mouse pointer or other GUI pointer, clicks on the anchor to invoke the link. The ‘anchor element’ is the entire markup from the start tag to the end tag.

The example of FIG. 5 also includes another hyperlink (312) also implemented by use of an anchor element. The hyperlink (312) is depicted with anchor “Today's Basketball scores.” An exemplary anchor element of hyperlink (312), here expressed in HTML, is:
<a href=“http:\\www.somesportspage.com/soccer/scores<date=mmddyyy>”>Today's Basketball Scores</a>

This example anchor element includes a start tag <a>, and end tag </a>, an href attribute that identifies the target of the link as dated content located at http:\\www.somesportspage.com/soccer/scores<date=mmddyyy>, and an anchor. In this example, the target of the hyperlink (312) has a date tag in the date field rather than an encoded date value. In such an example when the hyperlink is invoked, the browser of FIG. 5 replaces the date tag with the current date and requests the dated content using the URL bearing the current date instead of the date tag. In this example the date tag identifies the date format for date insertion as two digits for month, two digits for day, and four digits for year. The example browser of FIG. 5 may alternatively identify the date tag when the page is itself parsed and replace the date tag with the current date before displaying the web page. In such an alternative example, the URL already has the current date in the date field when the URL is invoked.

In the exemplary browser of FIG. 5, a menu entry called Bookmarks is programmed to display a pull-down menu (314) used to bookmark URLs for dated content in accordance with embodiments of the present invention. In the example of FIG. 5, the menu (314) includes an ‘Add Bookmark’ option (316) to bookmark a URL for dated content without modifying the URL. The ‘Add Bookmark’ function (316) advantageously provides a mechanism for bookmarking a URL to dated content that already has within its date field a date tag such as the exemplary hyperlink (312) of FIG. 5. When the bookmarked URL having the date tag in the date field is later invoked, the browser of FIG. 5 replaces the date tag with the current date and retrieves dated content using the URL bearing the current date.

The exemplary pull-down menu (314) also includes buttons for three add date enabled bookmark functions, one for each of three date tag formats: one for ‘mmddyyyy’ (318), one for ‘ddmmyyyy’ (320), and one for ‘mmddyy’ (322) for bookmarking URLs for dated content having encoded date values in their URLs with these three different date formats. Invoking one of the add date enabled bookmark options (318, 320, 322) of menu (314) of the browser of FIG. 5 instructs the browser to parse the URL identifying the web page presently displayed on the browser to identify an encoded date value and replace the encoded date value with a date tag in accordance with the selected date format (318, 320, 322) and bookmark the URL with the date tag instead of the encoded date.

The exemplary pull-down menu (314) of FIG. 5 also includes two bookmarks (324, 326) that point to the same dated content as the hyperlinks (310, 312). The bookmark (324) for today's soccer scores has an associated URL having an encoded date value in the date field such as:
www.somesportspage.com/soccer/scores06162004

Invoking the bookmark (324) causes the browser to receive the URL as a URL for dated content with a date field, parse the URL, replace the encoded date value 06162004 with the current date, and retrieve dated content for the current date through the use of the URL so modified with the current date.

The bookmark (326) has an associated URL with a date tag in the date field of the URL such as:
www.somesportspage.com/soccer/scores<date=mmddyyy>

Invoking the bookmark (324) instructs the browser to replace the date tag with a date value representing the current date in dependence upon the date format of the date tag and retrieve dated content through the use of a URL with the current date in the date field.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for retrieving dated content from a website, the method comprising:
receiving a URL for dated content with a date field;
inserting the current date in the date field; and
retrieving the dated content with the URL bearing the current date in its date field.

2. The method of claim 1 wherein the date field bears an encoded date and inserting the current date in the date field further comprises replacing the encoded date with the current date.

3. The method of claim 1 further comprising bookmarking the URL, including replacing an encoded date in the date field with a date tag.

4. The method of claim 3 further comprising prompting the user for a date format.

5. The method of claim 3 wherein the date tag further comprises a default date format.

6. The method of claim 3 further comprising configuring the browser with a default date format.

7. The method of claim 3 wherein inserting the current date in the date field further comprises replacing the date tag with the current date.

8. The method of claim 1 wherein receiving a URL for dated content with a date field further comprises providing the date field in the form of a date tag, wherein inserting the current date in the date field includes replacing the date tag with the current date.

9. The method of claim 1 further comprising bookmarking the URL, including a date field.

10. A system for retrieving dated content from a website, the system comprising:
means for receiving a URL for dated content with a date field;
means for inserting the current date in the date field; and
means for retrieving the dated content with the URL bearing the current date in its date field.

11. The system of claim 10 wherein the date field bears an encoded date and means for inserting the current date in the date field further comprises means for replacing the encoded date with the current date.

12. The system of claim 10 further comprising means for bookmarking the URL, including means for replacing an encoded date in the date field with a date tag.

13. The system of claim 12 further comprising means for prompting the user for a date format.

14. The system of claim 12 wherein the date tag further comprises a default date format.

15. The system of claim 12 further comprising means for configuring the browser with a default date format.

16. The system of claim 12 wherein means for inserting the current date in the date field further comprises means for replacing the date tag with the current date.

17. The system of claim 10 wherein means for receiving a URL for dated content with a date field further comprises means for providing the date field in the form of a date tag, wherein means for inserting the current date in the date field includes means for replacing the date tag with the current date.

18. The system of claim 10 further comprising means for bookmarking the URL, including a date field.

19. A computer program product for retrieving dated content from a website, the computer program product comprising:
a recording medium;
means, recorded on the recording medium, for receiving a URL for dated content with a date field;
means, recorded on the recording medium, for inserting the current date in the date field; and
means, recorded on the recording medium, for retrieving the dated content with the URL bearing the current date in its date field.

20. The computer program product of claim 19 wherein the date field bears an encoded date and means, recorded on the recording medium, for inserting the current date in the date field further comprises means, recorded on the recording medium, for replacing the encoded date with the current date.

21. The computer program product of claim 19 further comprising means, recorded on the recording medium, for bookmarking the URL, including means, recorded on the recording medium, for replacing an encoded date in the date field with a date tag.

22. The computer program product of claim 21 further comprising means, recorded on the recording medium, for prompting the user for a date format.

23. The computer program product of claim 21 wherein the date tag further comprises a default date format.

24. The computer program product of claim 21 further comprising means, recorded on the recording medium, for configuring the browser with a default date format.

25. The computer program product of claim 21 wherein means, recorded on the recording medium, for inserting the current date in the date field further comprises means, recorded on the recording medium, for replacing the date tag with the current date.

26. The computer program product of claim 19 wherein means, recorded on the recording medium, for receiving a URL for dated content with a date field further comprises means, recorded on the recording medium, for providing the date field in the form of a date tag, wherein means, recorded on the recording medium, for inserting the current date in the date field includes means, recorded on the recording medium, for replacing the date tag with the current date.

27. The computer program product of claim 19 further comprising means, recorded on the recording medium, for bookmarking the URL, including a date field.
